(19) United States
(12) Patent Application Publication
(10) Pub. No.: US 2023/0057484 A1
(43) Pub. Date: Feb. 23, 2023

(54) Philanthropy-Driven Social Media System and Related Method

(71) Applicant: Starfish Social Media, Inc., Newport Beach, CA (US)

(72) Inventors: Steven Mott, Newport Coast, CA (US); Carey Mott, Newport Coast, CA (US); John Cervenka, La Canada, CA (US); John Meader, Rancho Santa Fe, CA (US)

(21) Appl. No.: 17/890,942

(22) Filed: Aug. 18, 2022

Related U.S. Application Data
(60) Provisional application No. 63/259,953, filed on Aug. 23, 2021.

(51) Int. Cl. G06Q 50/00

(52) U.S. Cl. CPC G06Q 50/01

(57) ABSTRACT

A social media system includes processing hardware and a memory storing software code. The processing hardware executes the software code to receive beneficiary data identifying an entity selected by a system user to receive a donation, obtain a user profile of the system user, verify that the selected entity is a qualified charitable entity, and determine, in response to completing the verification, and using the user profile and the beneficiary data, one or more candidate contributor(s) of the donation. The processing hardware further executes the software code to identify one or more influencer(s) to promote the donation, obtain, from at least one of the identified influencer(s), an endorsement of the donation, issue a challenge to each of the candidate contributor(s) to contribute the donation, and inform the selected entity, in response to receiving an acceptance of the challenge from at least one of the candidate contributor(s), of the donation.

### RELATED APPLICATIONS

The present application claims the benefit of and priority to a pending Provisional patent application Ser. No. 63/259,953, filed Aug. 23, 2021, and titled “Starfish Social Media, an online platform for users to share their good stories and connect with other like-minded users and organizations.” which is hereby incorporated fully by reference into the present application.

### BACKGROUND

Conventional social media services, such as Facebook®. Instagram®, and LinkedIn®, for example, enable their users to network with friends and colleagues, and to broadcast details of their professional and personal lives, from the mundane to milestones, while also consuming the broadcasts of others. However, no existing social media service is purpose-driven to promote altruism and philanthropy. That is to say, although it is possible for a user of a conventional social media service to be charitable, and to encourage charitability by others, that functionality is merely incidental and is not purposefully engineered into those services. Nevertheless, there is a substantial societal need for outlets that encourage and enable compassion, altruism, and bridge building among individuals from diverse socio-economic, religious, geographical, and educational backgrounds. Thus, there is a need in the art for a social media system intentionally designed and technologically configured to encourage and facilitate collaborative charitable giving.

### BRIEF DESCRIPTION OF THE DRAWINGS

FIG. 1 illustrates and alludes to the motivation for the novel and inventive philanthropy-driven social media system disclosed by the present application;

FIG. 2 shows a block diagram overview of an exemplary philanthropy-driven social media system, according to one implementation;

FIG. 3A shows a diagram providing another exemplary representation of a philanthropy-driven social media system:

FIG. 3B shows the exemplary philanthropy-driven social media system of FIG. 3A in combination with a more detailed representation of a user system, according to one implementation;

FIG. 4 shows an illustration exemplifying the collaborative synergy encouraged and enabled by a philanthropy-driven social media system, according to one implementation;

FIG. 5A shows a screenshot of a user account creation page displayed via a graphical user interface (GUI) provided by a philanthropy-driven social media system, according to one exemplary implementation;

FIG. 5B shows a screenshot of a quick start page displayed via a GUI provided by a philanthropy-driven social media system, according to one exemplary implementation;

FIG. 5C shows a screenshot of a sponsor page displayed via a GUI provided by a philanthropy-driven social media system, according to one exemplary implementation:

FIG. 5D shows a screenshot of a qualified charitable entity page displayed via a GUI provided by a philanthropy-driven social media system, according to one exemplary implementation;

FIG. 5E shows a screenshot of an individual system user profile page displayed via a GUI provided by a philanthropy-driven social media system, according to one exemplary implementation;

FIG. 5F shows a screenshot of an introductory search page displayed via a GUI provided by a philanthropy-driven social media system, according to one exemplary implementation; and

FIG. 6 shows a flowchart describing an exemplary method for use by a philanthropy-driven social media system, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, no existing social media service is purpose-driven to promote altruism and philanthropy. Although it is possible for a user of a conventional social media service to be charitable, and to encourage charitability by others, that functionality is merely incidental and is not purposefully engineered into those services. Nevertheless and as also stated above, there is a substantial societal need for outlets that encourage and enable compassion, altruism, and bridge building among individuals from diverse socio-economic, religious, geographical, and educational backgrounds. In response to that need, the present application discloses a philanthropy-driven social media system intentionally designed and technologically configured to encourage and facilitate collaborative charitable giving.

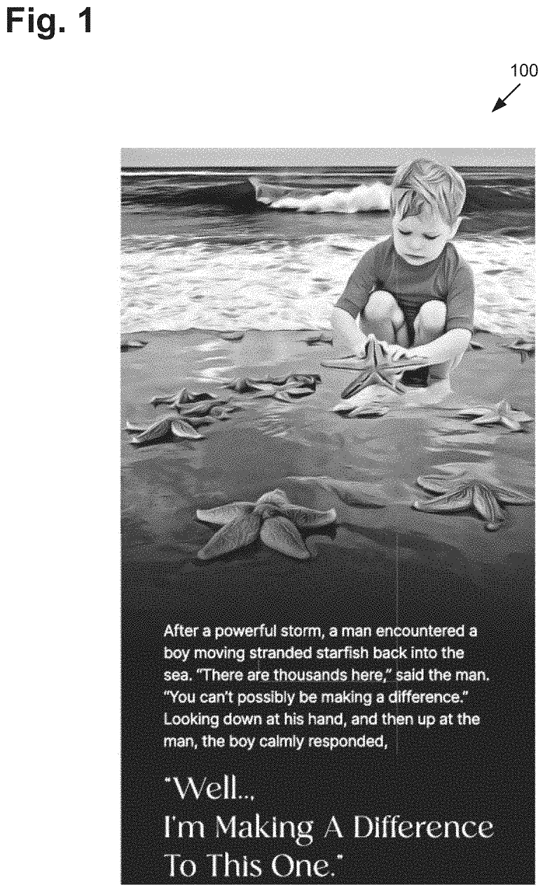

FIG. 1 illustrates and alludes to the motivation for the novel and inventive philanthropy-driven social media system disclosed by the present application. As shown and described by FIG. 1: “After a powerful storm, a man encountered a boy moving stranded starfish back into the sea. ‘There are thousands here,’ said the man. ‘You can't possibly be making a difference.’ Looking down at his hand, and then up at the man, the boy calmly responded, ‘well I am making a difference to this one.’” The parable embodied in FIG. 1 introduces the cascade effect made possible by doing good and communicating the desirability of doing good to others. Although initially skeptical of the boy's efforts in rescuing the starfish, the example of the boy's compassion and his ability to articulate a rationale for his actions may cause the skeptical man to lend his greater size and strength to the rescue effort, thereby amplifying the good produced by the actions of the boy. Inspired by this example, the present application discloses Starfish® Social Media.

It is noted that, in some implementations, the philanthropy-driven social media systems and methods disclosed by the present application may be substantially or fully automated. As defined in the present application, the terms “automation,” “automated.” and “automating” refer to systems and processes that do not require the participation of a human system operator. Although, in some implementations, a human system operator or administrator may review the performance of the automated systems and according to the automated methods described herein, that human involvement is optional. Thus, the methods described in the present application may be performed under the control of hardware processing components of the disclosed systems.

It is also noted that, as defined in the present application, the expression “machine learning model” refers to a mathematical model for making future predictions based on patterns learned from samples of data or “training data.” For example, machine learning models may be trained to perform image processing, natural language processing (NLP), and other inferential processing tasks. Various learning algorithms can be used to map correlations between input data and output data. These correlations form the mathematical model that can be used to make future predictions on new input data. Such a predictive model may include one or more logistic regression models, Bayesian models, or artificial neural networks (NNs). A “deep neural network,” in the context of deep learning, may refer to a NN that utilizes multiple hidden layers between input and output layers, which may allow for learning based on features not explicitly defined in raw data. As used in the present application, a feature identified as a NN refers to a deep neural network.

Moreover, and further by way of definition, it is noted that as used herein, the expression “system user” refers to any independent user of the philanthropy-driven social media system described herein. Examples of system users may include an individual person (hereinafter “individual system user”), a business entity such as a for-profit company, and a non-profit entity such as a qualified charitable organization (also known as a 501(c)(3) organization). In addition, the expression “sponsor” refers to a high net worth individual or for-profit company providing underwriting or other substantial financial support for a charitable campaign. Furthermore, the expression “influencer” refers to a celebrity or other influential media personality who may be recruited to initiate, promote, and in some instances contribute materially to, a charitable campaign.

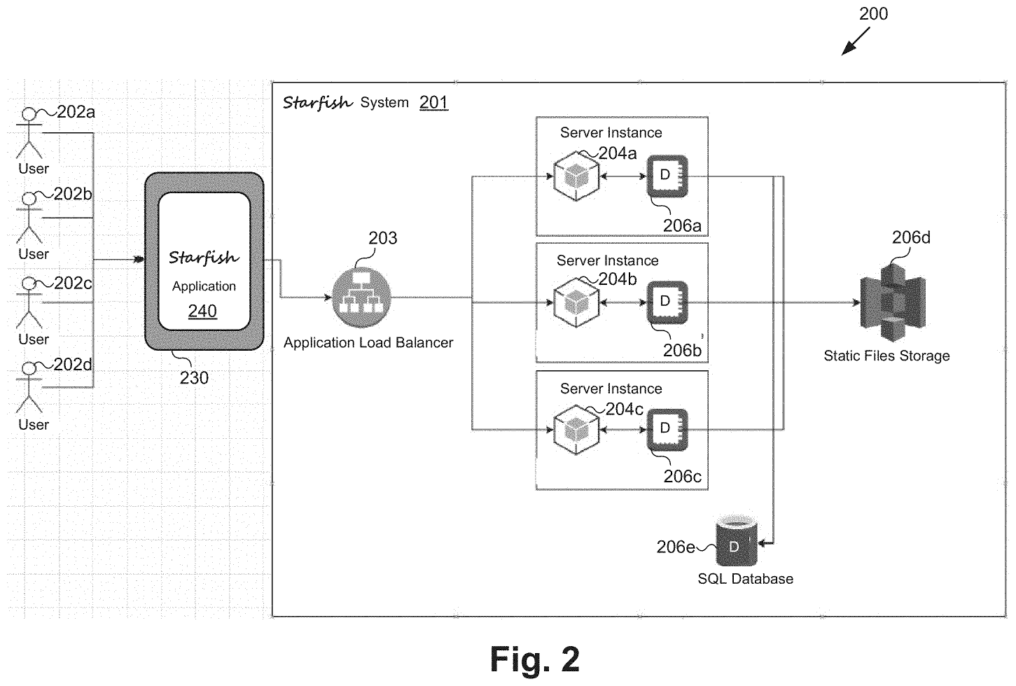

FIG. 2 shows block diagram overview 200 of exemplary philanthropy-driven social media (Starfish) system 201 (hereinafter “system 201”), according to one implementation. As shown in FIG. 2, system 201 includes application load balancer 203, processing hardware including multiple instances of servers 204a, 204b, and 204c, and memory resources including server databases 206a. 206b, and 206c, static files storage 206d, and Structured Query Language (SQL) database 206e. Also shown in FIG. 2 are multiple individual system users 202a. 202b. 202c, and 202d (hereinafter “individual system users 202a-202d”) each utilizing a user system corresponding in general to exemplary user system 230 and Starfish client application 240 (hereinafter “client application 240”) to interact with system 201.

It is noted that although FIG. 2 depicts four individual system users 202a-202d, that representation is merely exemplary. More generally, users of system 201 may number in the thousands, tens of thousands, hundreds of thousands, or millions of system users, for example. Thus, each of exemplary individual system users 202a-202d may correspond to multiple users of system 201.

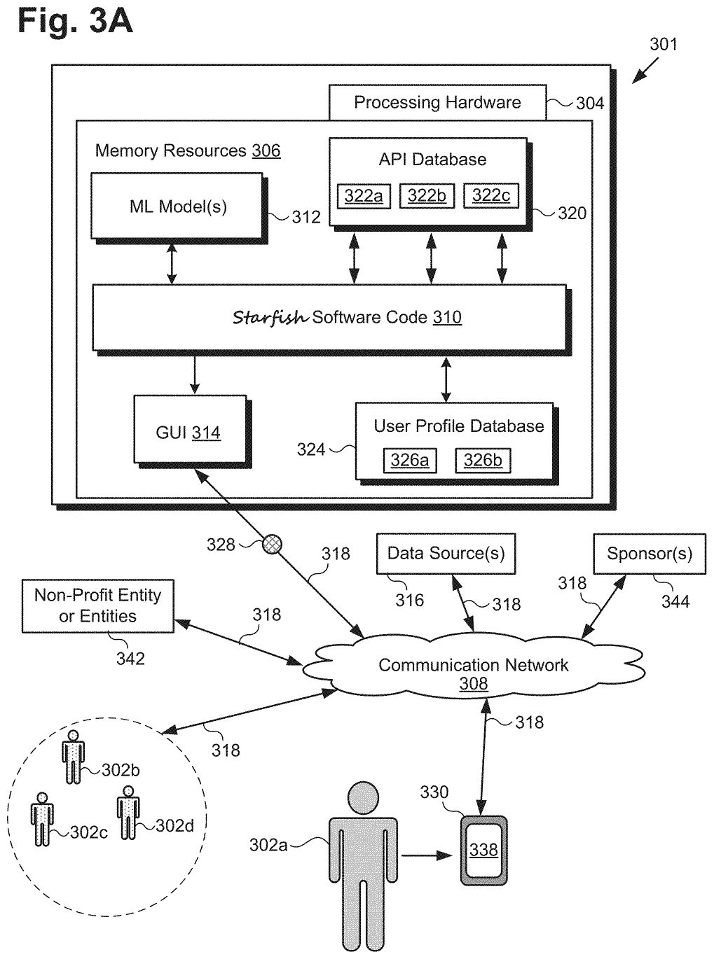

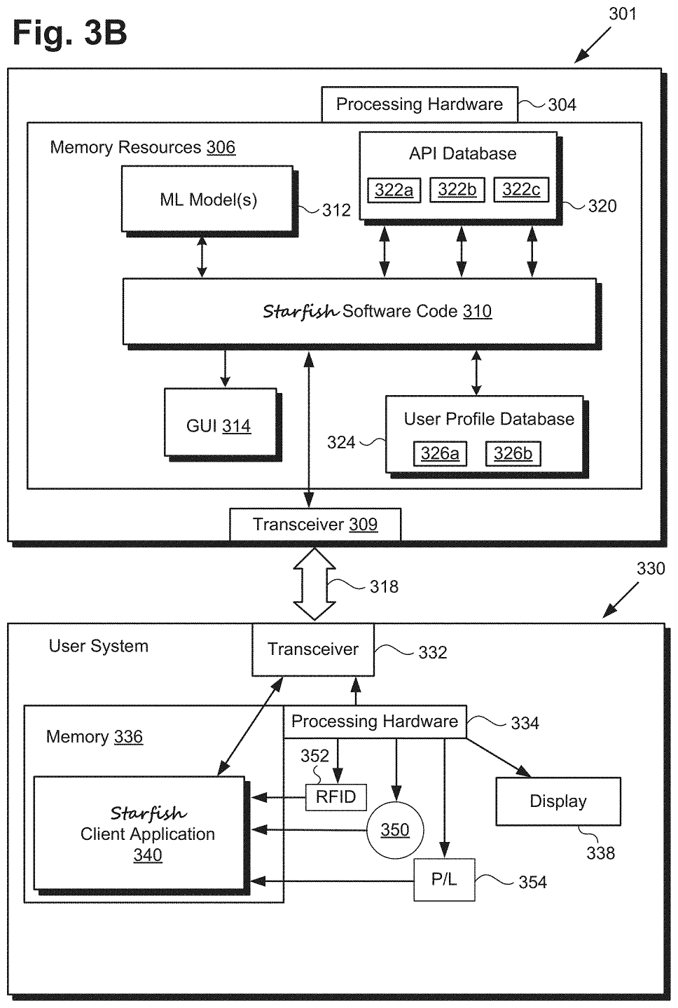

FIG. 3A shows a diagram providing another exemplary representation of philanthropy-driven social media system 301 (hereinafter “system 301”). It is noted that system 301 corresponds in general to system 201, in FIG. 2, and those corresponding features may share any of the characteristics attributed to either corresponding system by the present disclosure.

As shown in FIG. 3A, system 301 includes processing hardware 304 and memory resources 306 implemented as at least one computer-readable non-transitory storage medium. According to the present exemplary implementation, memory resources 306 stores Starfish software code 310 (hereinafter “software code 310”), one or more trained machine learning models 312 (hereinafter “trained ML model(s) 312”) such as NNs for example, Application Programming Interface database 320 (hereinafter “API database 320”) including APIs 322a, 322b, and 322c, and user profile database 324 including user profiles 326a and 326b. Also shown in FIG. 3A is graphical user interface (GUI) 314 for use by a system user to interact with system 301.

As further shown in FIG. 3A, system 301 is implemented within a use environment including communication network 308, user system 330 including display 338, and individual system user 302a utilizing user system 330 to interact with system 301 via communication network 308. In addition, FIG. 3A shows other individual system users 302b, 302c, and 302d of system 301, data sources 316 accessible by system 301 using communication network 308 and APIs 322a, 322b, and 322c, non-profit entity or entities 342, sponsor(s) 344, and beneficiary data 328 received by system 301 from a system user and identifying a non-profit entity selected by the system user to be a recipient of a donation. Also shown in FIG. 3A are network communication links 318 of communication network 308 interactively connecting system 301 with user system 330, data sources 316, one or more non-profit entities 342 (hereinafter “non-profit entity or entities 342”), and one or more sponsors 344 (hereinafter “sponsor(s) 344”).

It is noted that although API database 320 is shown to include three APIs 322a. 322b, and 322c, that representation is merely exemplary. In other implementations, API database 320 may include as few as one API, or more than three APIs, such as ten APIs, or more. It is further noted that although user profile database 324 is depicted as including two user profiles 326a and 326b, that representation too is provided merely by way of example. More generally, user profile database 324 may include a user profile for each user of system 301, including individual system users 302a. 302b, 302c, and 302d (hereinafter “individual system users 302a-302d”), sponsor(s) 344, and non-profit entity or entities 342.

Individual system users 302a-302d and user system 330 correspond respectively in general to individual system users 202a-202d and user system 230, in FIG. 2. Thus, individual system users 202a-202d and user system 230 may share any of the characteristics attributed to respective individual system users 302a-302d and user system 330 by the present disclosure, and vice versa. In addition, processing hardware 304 and memory resources 306 correspond respectively in general to the processing hardware and memory resources of system 201, in FIG. 2. Consequently, the processing hardware and memory resources of system 201 may share any of the characteristics attributed to respective processing hardware 304 and memory resources 306 by the present disclosure, and vice versa.

It is noted that memory resources 306 may take the form of any computer-readable non-transitory storage media. The expression “computer-readable non-transitory storage media,” as used in the present application, refers to any media, excluding a carrier wave or other transitory signal that provides instructions to processing hardware 304 of system 301. Thus, computer-readable non-transitory storage media may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs such as DVDs, RAM, programmable read-only memory (PROM), erasable PROM (EPROM), and FLASH memory.

Moreover, although FIG. 3A depicts to software code 310, trained ML model(s) 312. API database 320, and user profile database 324 as being co-located in a common memory, that representation is also provided merely as an aid to conceptual clarity. More generally, system 301 may include one or more computing platforms, such as servers 204a, 204b, and 204c in FIG. 2, which may be co-located, or may form an interactively linked but distributed system, such as a cloud-based system, for instance. As a result, processing hardware 304 and memory resources 306 may correspond to distributed processor and memory resources of system 301. Consequently, in some implementations, one or more of software code 310, trained ML model(s) 312. API database 320, and user profile database 324 may be stored remotely from one another on distributed memory resources 306 of system 301. It is also noted that, in some implementations, trained ML model(s) 312 may take the form of one or more software modules included in software code 310.

Processing hardware 304 may include multiple hardware processing units, such as one or more central processing units, one or more graphics processing units, and one or more tensor processing units, one or more field-programmable gate arrays (FPGAs), custom hardware for machine-learning training or machine-learning based prediction, and an API server, for example. By way of definition, as used in the present application, the terms “central processing unit” (CPU). “graphics processing unit” (GPU), and “tensor processing unit” (TPU) have their customary meaning in the ail. That is to say, a CPU includes an Arithmetic Logic Unit (ALU) for carrying out the arithmetic and logical operations of computing platform 102, as well as a Control Unit (CU) for retrieving programs, such as software code 310, from memory resources 306, while a GPU may be implemented to reduce the processing overhead of the CPU by performing computationally intensive graphics or other processing tasks. A TPU is an application-specific integrated circuit (ASIC) configured specifically for AI processes such as machine learning.

In some implementations, system 301 may include one or more web servers accessible over a packet-switched network such as the Internet, for example. Alternatively, or in addition, system 301 may include one or more computer servers supporting a wide area network (WAN), a local area network (LAN), or included in another type of private or limited distribution network. Furthermore, in some implementations, system 301 may be implemented virtually, such as in a data center. For example, in some implementations, system 301 may be implemented in software, or as virtual machines.

Referring to FIGS. 2 and 3A in combination, it is further noted that, although user system 230/330 is shown as a smartphone in those figures, that representation is provided merely by way of example. In other implementations, user system 230/330 may take the form of any suitable mobile or stationary computing device or system that implement data processing capabilities sufficient to provide GUI 314, support connections to communication network 308, and implement the functionality ascribed to user system 230/330 herein. That is to say, in other implementations, user system 230/330 may take the form of a desktop computer, laptop computer, tablet computer, digital media player, game console, or a wearable communication device such as a smartwatch, to name a few examples.

Referring to FIG. 3A alone, it is also noted that display 338 may take the form of a liquid crystal display (LCD), a light-emitting diode (LED) display, an organic light-emitting diode (OLED) display, a quantum dot (QD) display, or any other suitable display screen that perform a physical transformation of signals to light. Furthermore, display 338 may be physically integrated with user system 330 or may be communicatively coupled to but physically separate from user system 330. For example, where user system 330 is implemented as a smartphone, laptop computer, or tablet computer, display 338 will typically be integrated with user system 330. By contrast, where user system 330 is implemented as a desktop computer, display 338 may take the form of a monitor separate from user system 330 in the form of a computer tower.

FIG. 3B shows exemplary philanthropy-driven social media system 301 of FIG. 3A in combination with a more detailed representation of user system 330, according to one implementation. It is noted that any features in FIG. 3B identified by a reference number identical to a reference number used to identify a feature in FIG. 3A corresponds in general to that previously identified feature and may share any of the characteristics attributed to that corresponding feature by the present disclosure. As shown in FIG. 3B, user system 330 is communicatively coupled to system 301 by network communication link 318. In addition to the features of system 301 described above by reference to FIG. 3A. FIG. 3B shows system 301 to also include transceiver 309.

As further shown in FIG. 3B, user system 330 includes processing hardware 334 and memory 336 implemented as a non-transitory storage device storing Starfish client application 340 (hereinafter “client application 340”). As also shown in FIG. 3B, user system 330 may include any or all of transceiver 332, one or more cameras 350 (hereinafter “camera(s) 350”), radio-frequency identification (RFID) reader 352, one or more position/location sensors 354 (hereinafter “P/L sensor(s) 354”), and display 338.

As noted above, user system 330 corresponds in general to user system 230, in FIG. 2, and those corresponding features may share any of the characteristics attributed to either corresponding feature by the present disclosure. Thus, like user system 330, user system 230 may include features corresponding to processing hardware 334, transceiver 332, camera(s) 350. RFID reader 352, P/L sensor(s) 354, and memory 336 storing client application 240/340.

Transceiver 309 and transceiver 332 may be implemented as wireless communication hardware and software enabling system 301 to exchange data with user system 330 and via network communication link 318. For example, transceivers 309 and 332 may be implemented as any suitable wireless communication units. For example, transceivers 309 and 332 may be implemented as fourth generation (4G) wireless transceivers, or as 5G wireless transceivers. In addition, or alternatively, transceivers 309 and 332 may be configured for communications using one or more of Wireless Fidelity (Wi-Fi). Worldwide Interoperability for Microwave Access (WiMAX). Bluetooth. Bluetooth low energy, ZigBee, radio-frequency identification (RFID), near-field communication (NFC), and 60 GHz wireless communications methods.

Camera(s) 350 may include one or more red-green-blue (RGB) still image cameras, video cameras, or a combination of RGB still image and video cameras. In addition, in some implementations those RGB cameras may include a depth sensor. i.e., they may be RGB-D still image or video cameras. Moreover, in some implementations, camera(s) 350 may correspond to an array of RGB or RGB-D still image or video cameras configured to generate a panoramic image. P/L sensor(s) 354 may include one or more of accelerometers, gyroscopes, a GPS receiver, and a magnetometer, for example. In some implementations. P/L sensor(s) 354 may be implemented as an inertial measurement unit (IMU), as known in the art.

With respect to client application 240/340, it is noted that in some implementations, client application 240/340 may be a thin client application of software code 310. In those implementations, client application 240/340 may enable user system 230/330 to provide beneficiary data 328 to system 201/301 for processing. According to the exemplary implementation shown in FIG. 3B, client application 240/340 is located in memory 336 of user system 230/330, subsequent to transfer of client application 240/340 to user system 230/330 over a packet-switched network, such as the Internet, for example. Once present on user system 230/330, client application 240/340 may be persistently stored in memory 336 and may be executed locally on user system 230/330 by processing hardware 334.

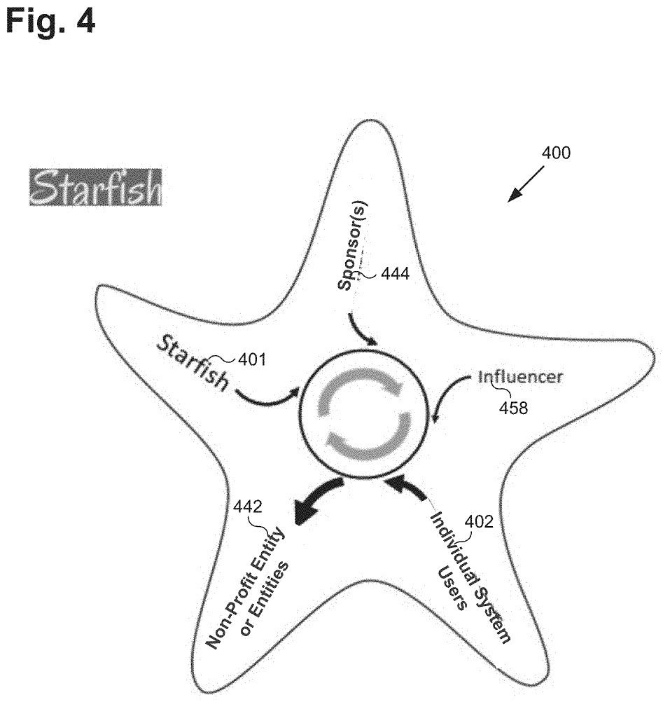

FIG. 4 shows illustration 400 exemplifying the collaborative synergy encouraged and enabled by a philanthropy-driven social media system, according to one implementation. As shown in FIG. 4, the five arms of a starfish can be envisioned as collaborating to initiate and amplify a charitable campaign for the benefit of non-profit entity or entities 442. By way of example, Starfish system 401 (hereinafter “system 401”) may be accessed by one of individual system users 402 who may initiate and serve as micro-donors to the charitable campaign, or may be accessed by one or more sponsors 444 (hereinafter “sponsor(s) 444”) or one or more influencers 458 (hereinafter “influencer(s) 458”) to initiate the charitable campaign identifying non-profit entity or entities 442 as a recipient of a donation. Moreover, the participation of one or both of sponsor(s) 444 and influencer(s) 458 may chum further micro-donor contributions to, sponsorships of, or further micro-donor contributions to and sponsorships of, the charitable campaign.

System 401 corresponds in general to system 201/301 in FIGS. 2, 3A, and 3B, and may share any of the characteristics attributed to that corresponding feature by the present disclosure. Individual system users 402, in FIG. 4, correspond in general to individual system users 202a-202d/302a-302d, in FIGS. 2 and 3A. Thus, individual system users 402 may share any of the characteristics attributed to individual system users 202a-202d/302a-302d by the present disclosure, and vice versa. Moreover, non-profit entity or entities 442 and sponsor(s) 444, in FIG. 4 correspond respectively in general to non-profit entity or entities 342 and sponsor(s) 344, in FIG. 3A. Consequently, non-profit entity or entities 442 and sponsor(s) 444 may share any of the characteristics attributed to respective non-profit entity or entities 342 and sponsor(s) 344 by the present disclosure, and vice versa.

As noted above, non-profit entity or entities 342/442 may take the form of one or more qualified charitable organization (also known as 501(c)(3) organizations) eligible for tax-exempt status under Section 501(c)(3) of United States Code Title 26. In addition and as also noted above, sponsor(s) 444 refer to one or more high net worth individuals or for-profit companies providing underwriting or other substantial financial support for a charitable campaign. Moreover and as further noted above, influencer(s) 458 refers to one or more celebrities or other influential media personalities who may be recruited to initiate, promote, and in some instances contribute materially to, a charitable campaign.

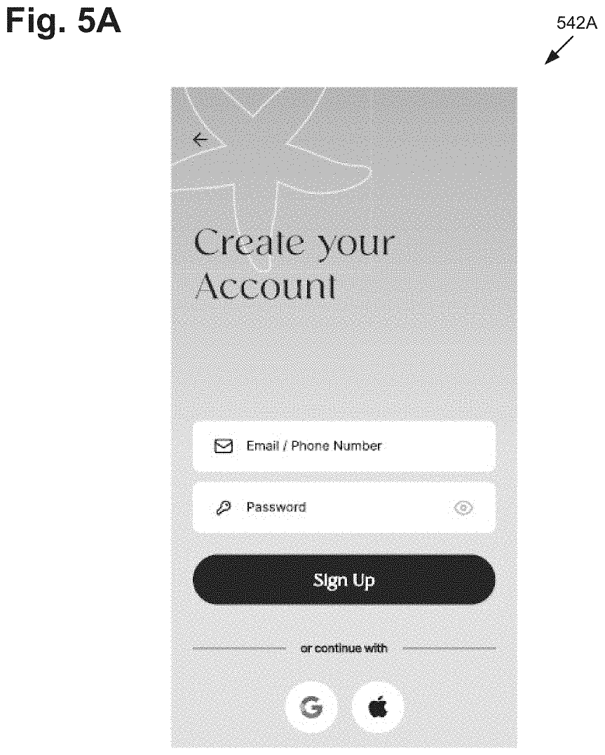

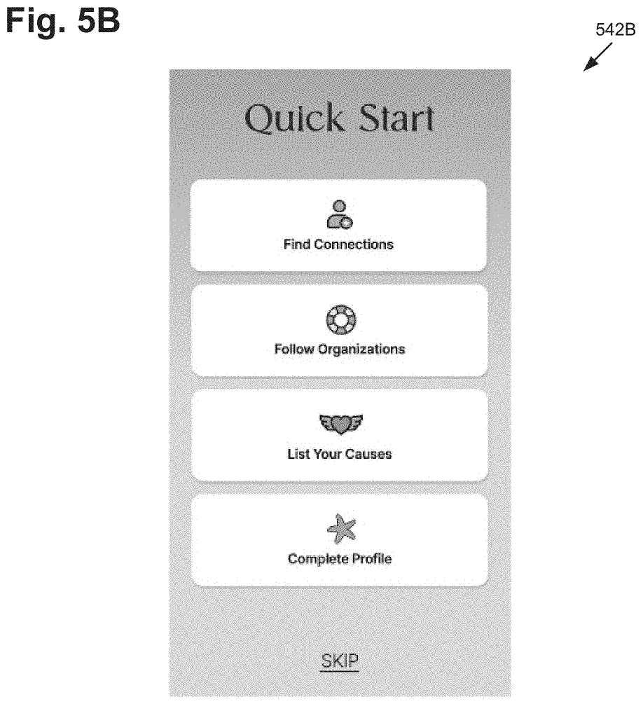

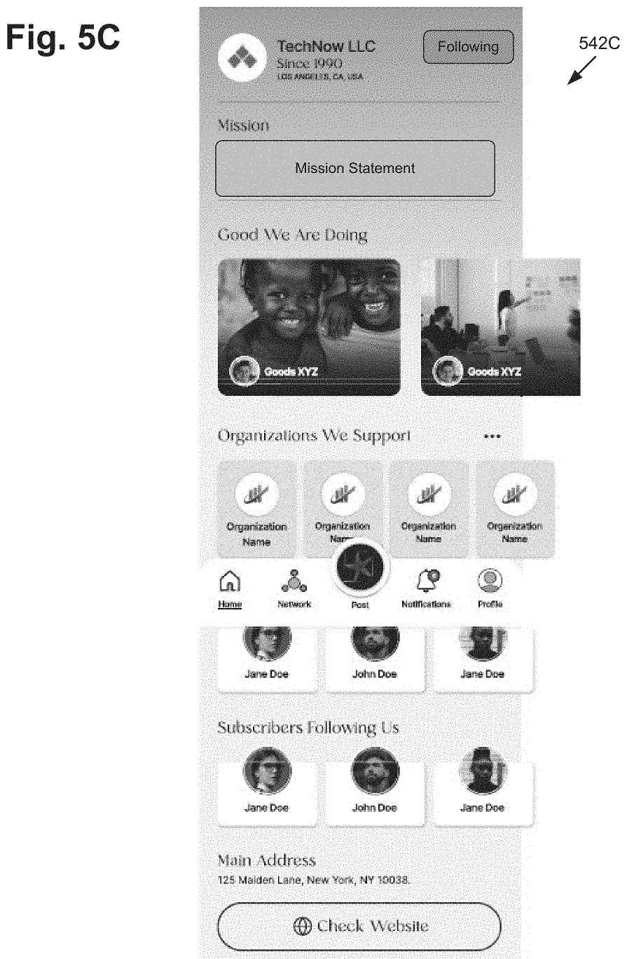

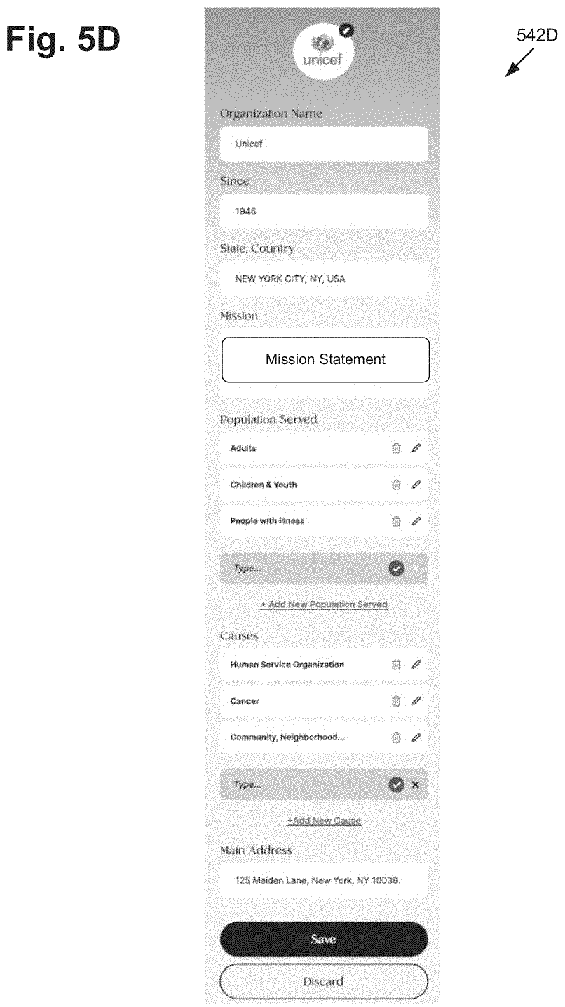

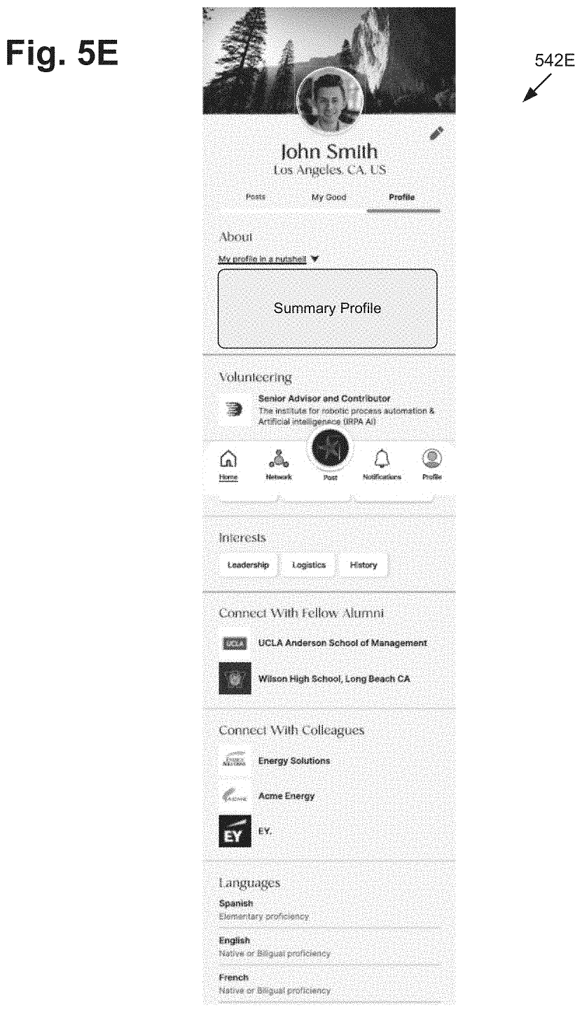

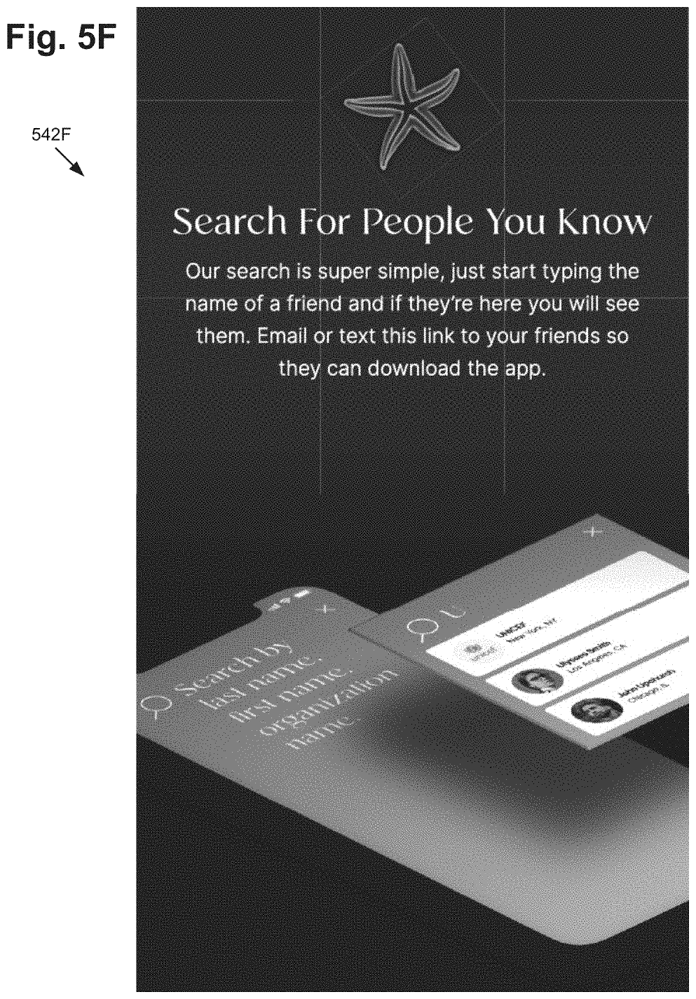

Referring to FIGS. 2, 3A, 3B, and 5A in combination, FIG. 5A shows a screenshot of user account creation page 542A displayed via GUI 314 provided by system 201/301, according to one exemplary implementation. As shown in FIG. 5A, GUI 314 enables a system user, such as one of individual system users 202a-202d/302a-302d/402 to create an account by providing either a valid email address or verifiable phone number, and then creating a unique password. Alternatively, user account creation page 542A advantageously enables the system user to create an account via a trusted third party, using an existing Google® or Apple® account of the system user, for example.

Referring to FIGS. 2, 3A, 3B, and 5B in combination, FIG. 5B shows a screenshot of quick start page 542B displayed via GUI 314 provided by system 201/301, according to one exemplary implementation. As shown in FIG. 5B, GUI 314 may provide an optional quick start page enabling a system user to find connections, follow organizations, i.e., non-profit entity or entities 342 and/or sponsor(s) 344, to list their personally supported charitable causes, and to complete their profile by adding information to their user profile. In addition, in the interests of enabling a system user to provide beneficiary data 328 without delay, quick start page 542B enables the system user to skip the options shown on quick start page 542B.

Referring to FIGS. 2, 3A. 3B, and 5C in combination. FIG. 5C shows a screenshot of sponsor page 542C displayed via GUI 314 provided by, according to one exemplary implementation. As shown in FIG. 5C, sponsor page 542C provides a platform for a for-profit company or other high net worth sponsor to identify it/them self, articulate a mission statement, identify the good. i.e., charitable campaigns the sponsor is presently involved with, identify other subscribers (hereinafter “individual system users”) following the sponsor, and may include an embedded Uniform Resource Identifier (URI), such as a Uniform Resource Locator (URL) for example, enabling a system user to navigate to a website of the sponsor through client application 240/340.

Referring to FIGS. 2, 3A. 3B, and 5D in combination, FIG. 5D shows a screenshot of qualified charitable entity page 542D displayed via GUI 314 provided by system 201/301, according to one exemplary implementation. As shown in FIG. 5D, qualified charitable entity page 542D provides a platform for a qualified charitable entity to identify itself and its history, articulate its mission statement, and identify the population or populations, e.g., human and/or animal, served by the qualified charitable entity, as well as the causes on which its mission is focused.

Referring to FIGS. 2, 3A. 3B, and 5E in combination. FIG. 5E shows a screenshot of individual system user profile page 542E displayed via GUI 314 provided by system 201/301, according to one exemplary implementation. As shown in FIG. 5E, individual system user profile page 542E identifies the individual system user be name and geographical location, lists his/her interests, educational affiliations, and corporate affiliations, as well as specific skills, such as language fluency, attained by the individual system user and possibly of benefit to a non-profit entity in need of volunteers.

Referring to FIGS. 2, 3A, 3B, and 5F in combination. FIG. 5F shows a screenshot introductory search page 542F displayed via GUI 314 provided by system 201/301, according to one exemplary implementation. Introductory search page 542F enables a system user to begin entering letters of a first name, last name, sponsor name, or non-profit entity name, and to advantageously have introductory search page 542F autofill the names of any individual system users, sponsors, or non-profit entities that include the name or partial name entered into the search page.

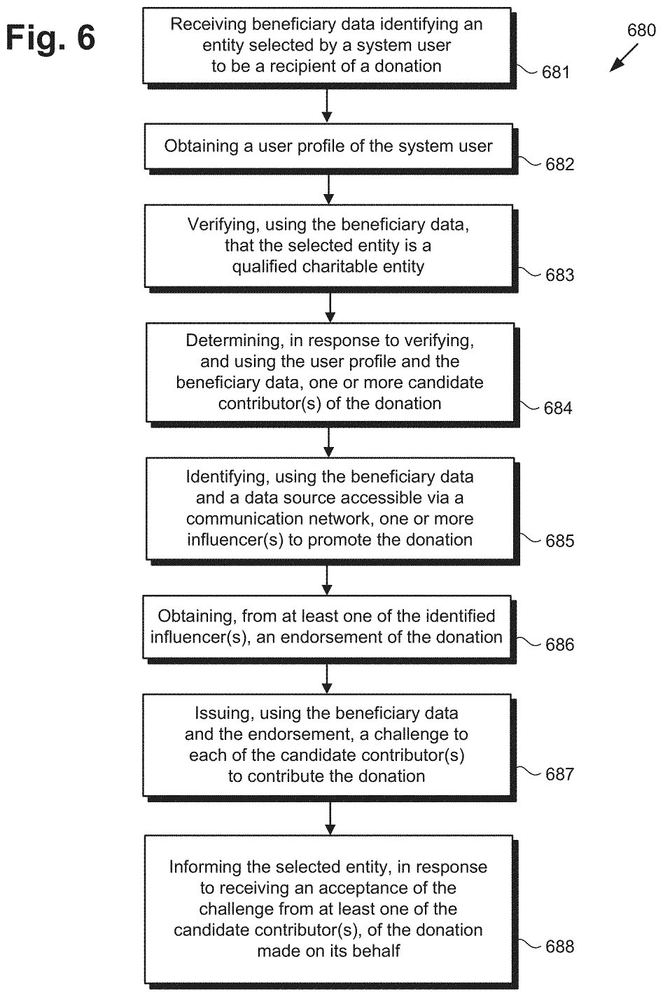

The functionality of system 201/301, in FIG. 2/3A/3B, will be further described by reference to FIG. 6. FIG. 6 shows flowchart 680 presenting an exemplary method for use by a philanthropy-driven social media system, such as system 201/301, according to one implementation. With respect to the method outlined in FIG. 6, it is noted that certain details and features have been left out of flowchart 680 in order not to obscure the discussion of the inventive features in the present application.

Referring to FIG. 6 in combination with FIGS. 2, 3A, and 4, flowchart 680 begins with receiving beneficiary data 328 identifying an entity selected by a system user, such as one of individual system users 202a-202d/302a-302d/402, sponsor(s) 344/444, or influencer 458 to be a recipient of a donation (action 681). As shown in FIG. 3A, beneficiary data 328 may be received by system 301, via GUI 314, communication network 308, and network communication links 318, using software code 310, executed by processing hardware 304.

Continuing to refer to FIGS. 2, 3A, 4, and 6 in combination, flowchart 680 further includes obtaining a user profile of the system user from which beneficiary data 328 is received in action 681 (action 682). As noted above, user profile database 324 may store user profiles 326a and 326b of system users, including individual system users 202a-202d/302a-302d/402, non-profit entity or entities 342/442, sponsor(s) 344/444, as well as, in some implementations, user profile(s) of influencer(s) 458. As shown in FIG. 5C, when the system user from which beneficiary data 328 is received in action 681 is one of sponsor(s) 344/444, the user profile of the sponsor may, in addition to identifying the sponsor, include a mission statement of the sponsor, identify the good, i.e., charitable campaigns the sponsor is presently involved with, and identify other individual system users following the sponsor.

As shown in FIG. 5E, when the system user from which beneficiary data 328 is received in action 681 is one of individual system users 202a-202d/302a-302d/402, the user profile of the individual system user, in addition to identifying the system user, may identify a geographical location of the system user, and may include his/her interests, educational affiliations, and corporate affiliations, as well as specific skills, such as language fluency, attained by the individual system user. In addition, a user profile of the individual system user will typically include a list of contacts or connections by the individual system user with other individual system users, sponsor(s), influencer(s), and a non-profit entity or entities. The user profile of the system user from which beneficiary data 328 is received in action 681 may be obtained, in action 682, by software code 310, executed by processing hardware 304, and using user profile database 324.

Moreover, when the system user from which beneficiary data 328 is received in action 681 is one of influencer(s) 458, the user profile of the influencer may identify charitable campaigns or social or political causes with which the influencer(s) is/are known to be associated.

Referring to FIGS. 3A and 6 in combination, flowchart 680 further includes verifying, using beneficiary data 328, that the selected entity is a qualified charitable entity (action 683). In some use cases, the entity selected by the system user and identified by beneficiary data 328 may be a present system user of system 301, in which case a user profile of the selected entity can be used to verify that the selected entity is a qualified charitable entity. However, in use cases in which the selected entity identified by beneficiary data 328 is not a system user of system 301, data source(s) 316, such as the Internal Revenue Service (IRS) or a database of qualified non-profit entities, for example, may be accessed and searched by system 301 to verify that the selected entity identified by beneficiary data 328 is a qualified charitable entity. Action 683 may be performed by software code 310, executed by processing hardware 304, and using one or more of APIs 322a. 322b, and 322c.

It is noted that although flowchart 680 lists action 683 as following action 682, that representation is merely exemplary. In various implementations, action 683 may precede action 682, may follow action 682 or may be performed in parallel with, i.e., contemporaneously with, action 682.

Referring to FIGS. 2, 3A, 4, and 6 in combination, flowchart 680 further includes determining, in response to verifying that the selected entity is a qualified charitable entity, and using the user profile obtained in action 682 and the beneficiary data received in action 681, one or more candidate contributors of the donation (action 684). It is noted that the candidate contributors determined in action 684 are typically micro-donor type individual system users 202a-202d/302a-302d/402.

When the system user from which beneficiary data 328 is received in action 681 is one of sponsor(s) 344/444, one or more of individual system users 202a-202d/302a-302d/402 may be identified as candidate contributors to the donation based on their professional or employment connections to the sponsor, because of association with other entities that the sponsor is also associated with, or because one or more personal contacts of the individual system user is associated with the sponsor, for example.

When the system user from which beneficiary data 328 is received in action 681 is one of individual system users 202a-202d/302a-302d/402, one or more others of individual system users 202a-202d/302a-302d/402 may be identified as candidate contributors to the donation based on their professional, employment, or educational connections to the sponsor, because of their association with other entities that the individual user initiating the charitable campaign is also associated with, because the candidate contributor is a contact of the individual system user initiating the charitable campaign, or because the individual system user initiating the charitable campaign shares one or more personal contacts in common with the candidate contributor, for example.

Furthermore, when the system user from which beneficiary data 328 is received in action 681 is one of influencer(s) 458, one or of individual system users 202a-202d/302a-302d/402 may be identified as candidate contributors to the donation based on their known admiration for the influencer, as discernable from their user profile for example, because of their support for other causes or charitable campaigns also supported by the influencer, because the influencer is popular or trending among contacts of the candidate contributor, or because the influencer is popular or trending among individual system users having user profiles similar to that of the candidate contributor, for example, based on demographics, geography, educational attainment, hobbies, interests, and the like.

The determination of one or more candidate contributors of the donation, in action 684, may be performed by software code 310, executed by processing hardware 304 of system 301. It is noted that in some implementations, determining the one or more candidate contributors of the donation uses a trained ML model included among trained ML model(s) 312 (i.e., a first trained ML model of trained ML model(s) 312). That is to say, in some implementations, action 684 may be performed by software code 310, executed by processing hardware 304, and using a first ML model trained to determine the one or more candidate contributors based on inputs including the user profile of the individual system user initiating the charitable campaign, user profiles of other individual system users 202a-202d/302a-302d/402, and beneficiary data 328.

Referring to FIGS. 3A, 4, and 6 in combination, flowchart 680 further includes identifying, using beneficiary data 328 and a data source among data sources 316 accessible via communication network 308, influencer(s) 458 to promote the donation identified by beneficiary data 328 (action 685). Examples of data sources 316 that may be used in action 685 include websites of influencers that identify charitable or social causes to which the influencers have expressed commitment or support, or a knowledge base describing various influencers and their respectively espoused charitable affiliations and interests.

The identification of influencer(s) 458 to promote the donation identified by beneficiary data 328, in action 685, may be performed by software code 310, executed by processing hardware 304 of system 301. It is noted that in some implementations, identifying influencer(s) 458 to promote the donation uses another trained ML model included among trained ML model(s) 312 (i.e., a second trained ML model of trained ML model(s) 312). That is to say, in some implementations, action 685 may be performed by software code 310, executed by processing hardware 304, and using a second ML model trained to identify one or more influencers to promote the donation based on inputs including the known charitable and social interests of a variety of different influencers.

Continuing to refer to FIGS. 3A, 4, and 6 in combination, flowchart 680 further includes obtaining, from at least one of influencer(s) 458 identified in action 685, an endorsement of the donation (action 686). By way of example, processing hardware 304 of system 301 may execute software code 310 to transmit a solicitation of an endorsement of the donation from some or all of influencer(s) 458, via GUI 314 or via communication network 308 and network communication links, until at least one of influencer(s) 458 agrees to provide the endorsement. Processing hardware 304 can then execute software code 310 to receive the one or more endorsements via GUI 314 or communication network 308 and network communication links 318.

Referring to FIGS. 3A and 6 in combination, flowchart 680 further includes issuing, using beneficiary data 328 and the endorsement or endorsements obtained in action 686, a challenge to each of the one or more candidate contributors determined in action 684, to contribute the donation (action 687). Action 687 may be performed by software code 310, executed by processing hardware 304, and using GUI 314, communication network 308 and network communication links 318.

Although not described in FIG. 6, in some implementations, before issuing the challenge to each of the one or more candidate contributors to contribute the donation, in action 687, processing hardware may further execute software code 310 to identify, using the user profile of the system user initiating the charitable campaign and beneficiary data 328, at least one sponsor of the donation. For example, when the entity selected by the system user to be the recipient of the donation is a large entity, one serving a large population of those in need, or one addressing a national or global challenge or crisis, donations from candidate contributors in the form of individual system users may be insufficient to adequately fund the charitable effort. In those use cases, identifying one or more high net worth individuals and/or for-profit companies capable of contributing substantial funding may be crucial to success of the charitable campaign. In implementations in which the method outlined by flowchart 680 includes identifying one or more sponsors of the donation, identification of the one or more sponsors is performed prior to action 687. Moreover, in those implementations, the challenge issued in action 687 may identify that/those sponsor(s).

The user profile of the system user from which beneficiary data 328 is received in action 681 may be used to identify high net worth individuals, for-profit companies, or both with which the system user has a professional, employment, or educational association, or those which are contacts of the system user or associated with contacts of the system user. In some use cases, such a sponsor or sponsors may be a present system user of system 301, in which case a user profile of the sponsor can be used to identify charitable interests of that sponsor, as well as enable prediction of the likelihood of sponsorship of the recipient of the donation identified by beneficiary data 328 by the potential sponsor. However, in use cases in which a potential sponsor is not a system user of system 301, data source(s) 316, such as one or more databases or knowledge bases describing charitable giving habits of major donors, for example, may be accessed and searched by system 301 to identify a sponsor of the donation and recipient identified by beneficiary data 328.

It is noted that in some implementations, identifying the one or more sponsors of the donation may use yet another trained ML model included among trained ML model(s) 312 (i.e., a third trained ML model of trained ML model(s)). That is to say, in some implementations, the identification of the one or more sponsors of the donation may be performed by software code 310, executed by processing hardware 304, and using a third ML model trained to identify the one or more sponsors inputs including the user profile of the individual system user initiating the charitable campaign and beneficiary data 328.

In some implementations, the donation identified by beneficiary data 328 may include a financial asset, such as an electronic funds transfer, a stock share, a bond, crypto currency, or a non-fungible token (NFT), for example. However, in other implementations, the donation identified by beneficiary data 328 may include participation in a volunteer effort. In those implementations in which the donation includes participation in a volunteer effort, the method outlined by flowchart 480 may further include, before issuing the challenge to each of the one or more candidate contributors to contribute the donation, in action 687, generating a map of the vicinity of a location of the volunteer effort, the map including a pin situated at the location. In some of those implementations, the pin may be selectable using GUI 314 to display one or more of an address of the location, an image of the location, an image of the system user initiating the charitable campaign, or an image of the one or more influencers endorsing the donation. In those implementations, the challenge issued in action 687 may also include the map. Generation of such a map may be performed by software code 310, executed by processing hardware 301 of system 301. Moreover, referring to FIG. 3B, the map may be displayed, and the pin may be selectable, using client application 340, GUI 314, and display 338 of user system 330, under the control of user system processing hardware 334.

In other implementations, the challenge issued in action 687 may include a live stream of a charitable event viewable via GUI 314. In some of those implementations, the issued challenge may enable each of the one or more candidate contributors to make the donation via a link included in the issued challenge. For example, a link accompanying the live stream may be selected via GUI 314 that redirects a candidate contributor viewing the challenge to a donation page, also provided via GUI 314, thereby empowering the candidate contributor to participate in the charitable event by donating financially or volunteering services, remotely.

Referring to FIGS. 3A and 6 in combination, flowchart 680 further includes informing the selected entity identified by beneficiary data 328, in response to receiving an acceptance of the challenge issued in action 687 from at least one of the one or more candidate contributors, of the donation made on its behalf (action 688). In use cases in which the entity selected to receive the donation is a system user, action 688 may be performed by software code 310, executed by processing hardware 304 of system 301, and using GUI 314. In use cases in which the entity selected to receive the donation is not yet a system user, action 688 may be performed by software code 310, executed by processing hardware 304 of system 301, via a communication sent using communication network 308 and network communication links 318 that may include an invitation to become a system user of system 301.

It is noted that, in use cases in which the donation identified by beneficiary data 328 includes contribution of a financial asset, processing hardware 304 of system 301 may further execute software code 310 to receive the financial asset into a qualified charitable entity maintained by the system 301, and to disburse the financial asset to the selected entity from the qualified charitable entity maintained by the social media system, in order to preserve tax-exempt status for the donation.

In use cases in which the donation identified by beneficiary data 328 includes contribution of a financial asset, processing hardware 304 of system 301 may also execute software code 310 to obtain, in response to receiving the acceptance of the challenge, a user profile of each of the candidate contributors accepting the challenge, and may determine, using those user profiles whether any of the candidate contributors accepting the challenge works for an employer providing a matching charitable gift program. In instances in which a candidate contributor that accepted the challenge does work for such an employer, processing hardware 304 may further execute software code 310 to obtain a charitable contribution from that employer that matches the donation by the candidate contributor. In addition, processing hardware 304 of system 301 may execute software code 310 to periodically generate and distribute donation acknowledgement letters to the contributors to charitable campaigns managed by system 301, where such donation acknowledgement letters satisfy IRS requirements as evidence of charitable giving.

It is further noted that, in some implementations, processing hardware 304 of system 301 may further execute software code 310 to obtain one or more key performance indicators (KPIs) of success of the challenge issued in action 687. Examples of such KPIs may include the absolute number of actual contributors of the donation, the number of actual contributors relative to candidate contributors, the total value of all donations, the average value of the donations, whether a funding goal was met, and the time required to meet such a funding goal, to name a few. Processing hardware 304 may then execute software code 310 to perform an assessment, using those one or more KPIs, of the contribution to the success of the challenge by at least one of: the one or more candidate contributors, the identified influencer(s) promoting the donation, or the sponsor or sponsors of the donation.

As noted above, in some implementations, a first trained ML model included among trained ML model(s) 312 may be used in action 684 to determine one or more candidate contributors to the donation identified by beneficiary data 328, while a second trained ML model of trained ML model(s) 312 may be used to perform action 685, and/or a third trained ML model of trained ML model(s) 312 may be used to identify one or more sponsors of the donation. In those implementations, one or more of the first trained ML model used in action 684, the second trained ML model used in action 685, or the third trained ML model used to identify the sponsor or sponsors of the donation may be further trained based on the assessment performed using the KPIs, in order to improve the automated performance of system 201/301 for future charitable campaigns.

With respect to the any of the actions described by reference to exemplary actions 681 through 688 of flowchart 680, it is noted that all of those actions may be performed as part of an automated process from which human involvement may be omitted.

Thus, the present application discloses a philanthropy-driven social media system and related method that address and overcome the deficiencies in the conventional art. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A social media system comprising:
a processing hardware and a memory storing a software code;
the processing hardware configured to execute the software code to:
receive beneficiary data identifying an entity selected by a system user to be a recipient of a donation;
obtain a user profile of the system user;
verify, using the beneficiary data, that the selected entity is a qualified charitable entity;
determine, in response to verifying, and using the user profile and the beneficiary data, one or more candidate contributors of the donation;
identify, using the beneficiary data and a data source accessible via a communication network, one or more influencers to promote the donation;
obtain, from at least one of the identified one or more influencers, an endorsement of the donation;
issue, using the beneficiary data and the endorsement, a challenge to each of the one or more candidate contributors to contribute the donation; and
inform the selected entity, in response to receiving an acceptance of the challenge from at least one of the one or more candidate contributors, of the donation.

2. The social media system of claim 1, wherein:
determining the one or more candidate contributors of the donation uses a first trained machine learning (ML) model; and
identifying the one or more influencers to promote the donation uses a second trained ML model.

3. The social media system of claim 1, wherein before issuing the challenge to each of the one or more candidate contributors to contribute the donation, the processing hardware is further configured to execute the software code to:
identify, using the user profile and the beneficiary data, a sponsor of the donation; and
wherein the issued challenge identifies the sponsor.

4. The social media system of claim 3, wherein:
determining the one or more candidate contributors of the donation uses a first trained machine learning (ML) model;
identifying the one or more influencers to promote the donation uses a second trained ML model; and
identifying the sponsor of the donation uses a third trained ML model.

5. The social media system of claim 4, wherein the processing hardware is further configured to execute the software code to:
obtain one or more key performance indicators (KPIs) of success of the challenge;
perform an assessment, using the one or more KPIs, of a contribution to the success of the challenge by at least one of: the one or more candidate contributors, the at least one of the identified one or more influencers promoting the donation, or the sponsor of the donation; and
wherein at least one of the first trained ML model, the second trained ML model, or the third trained ML model is further trained based on the assessment.

6. The social media system of claim 1, wherein the donation comprises participation in a volunteer effort, and wherein before issuing the challenge to each of the one or more candidate contributors to contribute the donation, the processing hardware is further configured to execute the software code to:
generate a map of a vicinity of a location of the volunteer effort, the map including a pin situated at the location;
the pin being selectable to display one or more of an address of the location, an image of the location, an image of the system user, or an image of the at least one of the identified one or more influencers endorsing the donation; and
wherein the issued challenge includes the map.

7. The social media system of claim 1, wherein the donation comprises a financial asset, and wherein the processing hardware is further configured to execute the software code to:
receive, into a qualified charitable entity maintained by the social media system, the financial asset; and
disburse the financial asset to the selected entity from the qualified charitable entity maintained by the social media system, to preserve a tax-exempt status of the donation.

8. The social media system of claim 7, wherein the financial asset comprises at least one of an electronic funds transfer, a stock share, a bond, crypto currency, or a non-fungible token (NFT).

9. The social media system of claim 7, wherein the processing hardware is further configured to execute the software code to:
obtain, in response to receiving the acceptance of the challenge from the at least one of the one or more candidate contributors, a user profile of the at least one of the one or more candidate contributors;
determine, using the user profile of the at least one of the one or more candidate contributors, whether the at least one of the one or more candidate contributors works for an employer providing a matching charitable gift program;
obtain from the employer, when determining determines that the employer provides the matching gift program, a charitable contribution matching the donation; and
disburse the charitable contribution matching the donation to the selected entity.

10. The social media system of claim 1, wherein the issued challenge comprises a live stream of a charitable event, and wherein the issued challenge enables each of the one or more candidate contributors to make the donation via a link included in the issued challenge.

11. A method for use by a social media system including a processing hardware, and a system memory storing a software code, the method comprising:
receiving, by the software code executed by the processing hardware, beneficiary data identifying an entity selected by a system user to be a recipient of a donation;
obtaining, by the software code executed by the processing hardware, a user profile of the system user;
verifying, by the software code executed by the processing hardware and using the beneficiary data, that the selected entity is a qualified charitable entity;
determining, by the software code executed by the processing hardware in response to verifying, and using the user profile and the beneficiary data, one or more candidate contributors of the donation;
identifying, by the software code executed by the processing hardware and using the beneficiary data and a data source accessible via a communication network, one or more influencers to promote the donation;
obtaining, by the software code executed by the processing hardware from at least one of the identified one or more influencers, an endorsement of the donation;
issuing, by the software code executed by the processing hardware and using the beneficiary data and the endorsement, a challenge to each of the one or more candidate contributors to contribute the donation; and
informing the selected entity, by the software code executed by the processing hardware in response to receiving an acceptance of the challenge from at least one of the one or more candidate contributors, of the donation.

12. The method of claim 11, wherein:
determining the one or more candidate contributors of the donation uses a first trained machine learning (ML) model; and
identifying the one or more influencers to promote the donation uses a second trained ML model.

13. The method of claim 11, further comprising, before issuing the challenge to each of the one or more candidate contributors to contribute the donation:
identify, by the software code executed by the processing hardware and using the user profile and the beneficiary data, a sponsor of the donation; and
wherein the issued challenge identifies the sponsor.

14. The method of claim 13, wherein:
determining the one or more candidate contributors of the donation uses a first trained machine learning (ML) model;
identifying the one or more influencers to promote the donation uses a second trained ML model; and
identifying the sponsor of the donation uses a third trained ML model.

15. The method of claim 14, further comprising:
obtaining, by the software code executed by the processing hardware, one or more key performance indicators (KPIs) of success of the challenge;
performing an assessment, by the software code executed by the processing hardware and using the one or more KPIs, of a contribution to the success of the challenge by at least one of: the one or more candidate contributors, the at least one of the identified one or more influencers promoting the donation, or the sponsor of the donation; and
wherein at least one of the first trained ML model, the second trained ML model, or the third trained ML model is further trained based on the assessment.

16. The method of claim 11, wherein the donation comprises participation in a volunteer effort, the method further comprising, before issuing the challenge to each of the one or more candidate contributors to contribute the donation:
generating, by the software code executed by the processing hardware, a map of a vicinity of a location of the volunteer effort, the map including a pin situated at the location;
the pin being selectable to display one or more of an address of the location, an image of the location, an image of the system user, or an image of the at least one of the identified one or more influencers endorsing the donation; and
wherein the issued challenge includes the map.

17. The method of claim 11, wherein the donation comprises a financial asset, the method further comprising:
receiving, by the software code executed by the processing hardware, into a qualified charitable entity maintained by the social media system, the financial asset; and
disbursing, by the software code executed by the processing hardware, the financial asset to the selected entity from the qualified charitable entity maintained by the social media system, to preserve a tax-exempt status of the donation.

18. The method of claim 17, wherein the financial asset comprises at least one of an electronic funds transfer, a stock share, a bond, crypto currency, or a non-fungible token (NFT).

19. The method of claim 17, wherein the processing hardware is further configured to execute the software code to:
obtaining, by the software code executed by the processing hardware in response to receiving the acceptance of the challenge from the at least one of the one or more candidate contributors, a user profile of the at least one of the one or more candidate contributors;
determining, by the software code executed by the processing hardware and using the user profile of the at least one of the one or more candidate contributors, whether the at least one of the one or more candidate contributors works for an employer providing a matching charitable gift program;
obtaining from the employer, by the software code executed by the processing hardware when determining determines that the employer provides the matching gift program, a charitable contribution matching the donation; and
disbursing the charitable contribution matching the donation to the selected entity.

20. The method of claim 11, wherein the issued challenge comprises a live stream of a charitable event, and wherein the issued challenge enables each of the one or more candidate contributors to make the donation via a link included in the issued challenge.
